(19) United States
(12) Patent Application Publication
(10) Pub. No.: US 2018/0363500 A1
(43) Pub. Date: Dec. 20, 2018

(54) NON-SYMMETRIC BALL BEARING SYSTEM FOR A TURBOCHARGER

(71) Applicant: BorgWarner Inc., Auburn Hills, MI (US)

(72) Inventor: Christian C. LONGACRE, Arden, NC (US)

(21) Appl. No.: 15/780,854

(22) PCT Filed: Nov. 22, 2016
(86) PCT No.: PCT/US2016/063259

§ 371 Date: Jun. 1, 2018

Related U.S. Application Data
(60) Provisional application No. 62/263,139, filed on Dec. 4, 2015.

(51) Int. Cl. F01D 25/16; F16C 27/04; F16C 33/66

(52) U.S. Cl. CPC F01D 25/16; F16C 27/045; F16C 19/184; F05D 2220/40; F05D 2260/98; F16C 33/6659

(57) ABSTRACT

A number of variations may include an outer race (12) having a first inner circumferential surface defining a first passage, a first inner race (18) defining a second passage and a second inner race (22) defining a third passage wherein the first inner race and second inner race may be disposed within the first passage and may include a first plurality of ball bearings disposed at a first contact angle between the first inner race and the outer race and a second plurality of ball bearings disposed at a second contact angle between the second inner race and the outer race and where the outer race may include a first outer circumferential surface defining at least a first oil jet constructed and arranged to provide lubricant to the first plurality of ball bearings and at least a second oil jet constructed and arranged to provide lubricant to the second plurality of ball bearings.

### CROSS-REFERENCE TO RELATED APPLICATIONS

This application claims the benefit of U.S. Provisional Application No. 62/263,139 filed Dec. 4, 2015.

### TECHNICAL FIELD

The field to which the disclosure generally relates includes ball bearing systems.

### BACKGROUND

Bearing systems within turbochargers operate in substantially different conditions on the turbine side and the compressor side of a turbocharger housing.

### SUMMARY OF ILLUSTRATIVE VARIATIONS

A number of variations may include a ball bearing system that may include an outer race having a first inner circumferential surface defining a first passage, a first inner race defining a second passage and a second inner race defining a third passage wherein the first inner race and second inner race may be disposed within the first passage and further may include a first plurality of ball bearings disposed at a first contact angle between the first inner race and the outer race and a second plurality of ball bearings disposed at a second contact angle between the second inner race and the outer race and where the outer race further may include a first outer circumferential surface defining at least a first oil jet constructed and arranged to provide a lubricant to the first plurality of ball bearings and at least a second oil jet constructed and arranged to provide a lubricant to the second plurality of ball bearings.

Other illustrative variations within the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts one variation of a non-symmetric ball bearing system.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are considered to be within the scope of the invention.

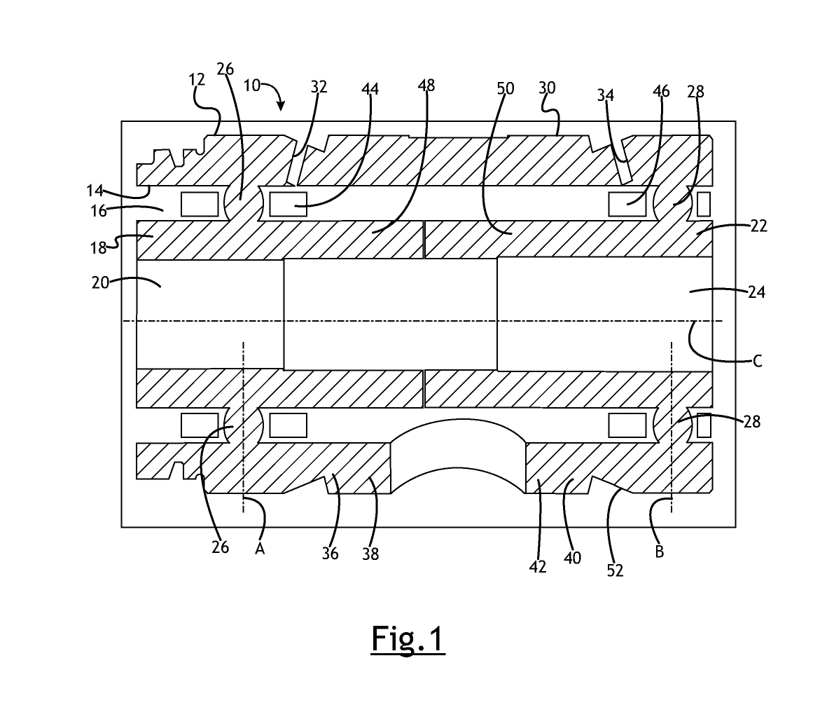

Referring to FIG. 1, a ball bearing system 10 may include an outer race 12 having a longitudinal axis (C) having a squeeze film damper surface 54 and a first inner circumferential surface 14 defining a first passage 16 and wherein the outer race 12 further may include a circumferential oil groove 52 and a first outer race 36 may include a first outer race material 38 and a second outer race 40 may include a second outer race material 42 wherein the first outer race material 38 and the second outer race material 42 are different. The ball bearing system 10 may further include a first inner race 18 defining a second passage 20 and a second inner race 22 defining a third passage 24 wherein the first inner race 18 and second inner race 22 are disposed within the first passage 16 to define a shaft passage including the second passage 20 and the third passage 24. The ball bearing system 10 may include a first plurality of ball bearings 26 disposed at a first contact angle (A) between the first inner race 18 and the outer race 12 and a second plurality of ball bearings 28 disposed at a second contact angle (B) between the second inner race 22 and the outer race 12 and wherein the first contact angle may be a different angle than that of the second contact angle. The first inner race 18 may include a first inner race material 48 and the second inner race 22 may include a second inner race material 50 wherein the first inner race material 48 and the second inner race material 50 are different. The outer race 12 may further include a first outer circumferential surface 30 defining a at least a first oil jet 32 constructed and arranged to provide a lubricant to the first plurality of ball bearings 26 and at least a second oil jet 34 constructed and arranged to provide a lubricant to the second plurality of ball bearings 28. The first plurality of ball bearings 26 may include a first diameter and the second plurality of ball bearings 28 may include a second diameter wherein the first diameter and the second diameter are different and wherein the first plurality of ball bearings 26 may also include a different number of ball bearings than the second plurality of ball bearings 28. The ball bearing system 10 may further include a first cage 44 disposed between the outer race 12 and the first inner race 18 constructed and arranged to hold the first plurality of ball bearings 26 and a second cage 46 disposed between the outer race 12 and the second inner race 22 constructed and arranged to hold the second plurality of ball bearings 28.

The ball bearing system may be constructed and arranged to be utilized within a turbocharger housing wherein the first inner race, second passage, first plurality of ball bearings, first cage, first outer race, and first oil jet may be constructed and arranged to be in fluid communication with a compressor side of a turbocharger housing. Additionally, the ball bearing system may be constructed and arranged to be utilized within a turbocharger housing wherein the second inner race, third passage, second plurality of ball bearings, second cage, second outer race, and second oil jet may be constructed and arranged to be in fluid communication with a turbine side of a turbocharger housing. In some cases, the turbine side of a turbocharger housing may require components to operate at a higher temperature, higher cost, and higher performance than the compressor side of a turbocharger housing. Additionally, the first cage may be utilized on the compressor side of a turbocharger housing and may include a lower cost, lower temperature capable material than the second cage which may be utilized on the turbine side of a turbocharger housing. The first inner race, the second inner race, the first outer race, the second outer race may all share a common longitudinal axis (C).

The ball bearing system may additionally be constructed and arranged to incorporate squeeze film damping wherein the squeeze film damper surface(s) may have different clearances on the first out race and the second outer race.

Additionally, the first oil jet and the second oil jet may be constructed and arranged to provide different oil flow rates to the compressor side or turbine side or first plurality of ball bearings or the second plurality of ball bearings of the ball bearing system.

The first contact angle (A) and the second contact angle (B) may vary to account for thrust load magnitudes within the ball bearings system wherein a relatively smaller angle for lower thrust load.

The ball bearing system may include a decoupling ring or decoupling rings (not shown) that may center a rotor during low-speed operation.

As one of ordinary skill in the art will appreciate, the ball bearing system may include a number of variations with respect to component geometry, component materials, and components physical characteristics and properties and still remain within the scope of the disclosed variations. For example, the first, second, or third plurality of bearings may include varying ball bearing dimensions, materials, and ball bearing count. Likewise, the first and second oil jets, or additional oil jets, may be constructed and arranged to accommodate for any variations within the first, second, or third plurality of ball bearings. Similarly, the first and second outer races and first and second inner races may include dimensions and materials

According to variation 1, a ball bearing system 10 may include an outer race 12 having a first inner circumferential surface 14 defining a first passage 16, a first inner race 18 defining a second passage 20 and a second inner race 22 defining a third passage 24 wherein the first inner race 18 and second inner race 22 may be disposed within the first passage 16 and further may include a first plurality of ball bearings 26 disposed at a first contact angle (A) between the first inner race 18 and the outer race 12 and a second plurality of ball bearings 28 disposed at a second contact angle (B) between the second inner race 22 and the outer race 12 and where the outer race 12 further may include a first outer circumferential surface 30 defining at least a first oil jet 32 constructed and arranged to provide a lubricant to the first plurality of ball bearings 26 and at least a second oil jet 34 constructed and arranged to provide a lubricant to the second plurality of ball bearings 28.

Variation 2 may include a product as set forth in variation 1 wherein the outer race 12 further may include a circumferential oil groove 52 and a first outer race 36 may include a first outer race material 38 and a second outer race 40 may include a second outer race material 42 wherein the first outer race material 38 and the second outer race material 42 are different.

Variation 3 may include a product as set forth in variation 1 or 2 further may include a first cage 44 disposed between the outer race 12 and the first inner race 18 constructed and arranged to hold the first plurality of ball bearings 26 and a second cage 46 disposed between the outer race 12 and the second inner race 22 constructed and arranged to hold the second plurality of ball bearings 28. The first cage and second cage may feature different ball pocket diameters, inner diameter, outer diameter, and thickness based on stresses put on the first cage or second cage. Additionally, the first cage and second cage may comprise various materials and coatings constructed and arranged to accommodate for various stresses within the ball bearing system.

Variation 4 may include a product as set forth in any of variations 1 through 3 wherein the first inner race 18 may include a first inner race material 48 and the second inner race 22 may include a second inner race material 50 wherein the first inner race material 48 and the second inner race material 50 are different.

Variation 5 may include a product as set forth in any of variations 1 through 4 wherein the first plurality of ball bearings 26 may include a first diameter and the second plurality of ball bearings 28 may include a second diameter wherein the first diameter and the second diameter are different.

Variation 6 may include a product as set forth in any of variations 1 through 5 wherein the first plurality of ball bearings 26 may include a different number of ball bearings than the second plurality of ball bearings 28.

Variation 7 may include a product as set forth in any of variations 1 through 6 wherein the first contact angle is a different angle than that of the second contact angle.

Variation 8 may include a product as set forth in any of variations 1 through 7 further including a third plurality of ball bearings disposed adjacent the first plurality of ball bearings, the second plurality of ball bearings, or both.

The above description of variations of the invention is merely demonstrative in nature and, thus, variations thereof are not to be regarded as a departure from the spirit and scope of the inventions disclosed within this document.

What is claimed is:

1. A product comprising:
a ball bearing system comprising an outer race having a first inner circumferential surface defining a first passage, a first inner race defining a second passage and a second inner race defining a third passage wherein the first inner race and second inner race are disposed within the first passage and further comprising a first plurality of ball bearings disposed at a first contact angle between the first inner race and the outer race and a second plurality of ball bearings disposed at a second contact angle between the second inner race and the outer race and where the outer race further comprises a first outer circumferential surface defining at least a first oil jet constructed and arranged to provide a lubricant to the first plurality of ball bearings and at least a second oil jet constructed and arranged to provide a lubricant to the second plurality of ball bearings.

2. A product as set forth in claim 1 wherein the outer race further comprises a circumferential oil groove and a first outer race comprising a first outer race material and a second outer race comprising a second outer race material wherein the first outer race material and the second outer race material are different.

3. A product as set forth in claim 1 further comprising a first cage disposed between the outer race and the first inner race constructed and arranged to hold the first plurality of ball bearings and a second cage disposed between the outer race and the second inner race constructed and arranged to hold the second plurality of ball bearings.

4. A product as set forth in claim 1 wherein the first inner race comprises a first inner race material and the second inner race comprises a second inner race material wherein the first inner race material and the second inner race material are different.

5. A product as set forth in claim 1 wherein the first plurality of ball bearings comprises a first diameter and the second plurality of ball bearings comprises a second diameter wherein the first diameter and the second diameter are different.

6. A product as set forth in claim 1 wherein the first plurality of ball bearings comprises a different number of ball bearings than the second plurality of ball bearings.

7. A product as set forth in claim 1 wherein the first contact angle is a different angle than the second contact angle.

8. A product as set forth in claim 1 further comprising a third plurality of ball bearings disposed adjacent at least one of the first plurality of ball bearings, the second plurality of ball bearings, or both.
